(19) United States
(12) Patent Application Publication
(10) Pub. No.: US 2020/0233100 A1
(43) Pub. Date: Jul. 23, 2020

(54) X-Ray Detector With Multi-Layer Dielectric Reflector

(71) Applicant: Viken Detection Corporation, Burlington, MA (US)

(72) Inventor: Peter J. Rothschild, Newton, MA (US)

(21) Appl. No.: 16/751,159

(22) Filed: Jan. 23, 2020

Related U.S. Application Data
(60) Provisional application No. 62/795,759, filed on Jan. 23, 2019.

(51) Int. Cl. G01T 1/20

(52) U.S. Cl. CPC G01T 1/2002; G01T 1/2006

(57) ABSTRACT

An x-ray detector and a corresponding method of detecting x-rays are disclosed. The detector includes a scintillator structure, light guide, multi-layer dielectric reflective material, and photodetector. The scintillator receives incident x-rays and produces scintillation light. The light guide is mechanically and optically coupled to the scintillator and guides the scintillation light to the photodetector, assisted by the multi-layer dielectric, which at least partially surrounds the light guide and scintillator and confines the scintillation light within the light guide via reflection. The detector can enable transmission imaging using an x-ray pencil beam of a backscatter imaging system so that backscatter and transmission images can be obtained in the same scan. Use of the multi-layer dielectric reflector facilitates compact, inexpensive, flexible, multi-channel detector arrangements from which superior transmission imaging can be obtained, compared with existing detectors.

### RELATED APPLICATION

This application claims the benefit of U.S. Provisional Application No. 62/795,759, filed on Jan. 23, 2019. The entire teachings of the above application are incorporated herein by reference.

### BACKGROUND

The use of backscatter x-ray imaging for security applications is becoming more widespread for border security and for infrastructure protection. These systems require the use of scanning pencil beams of x-rays to form the backscatter images and do not use fan beams of radiation, which are typically used in transmission imaging systems. In addition to creating backscatter images, it is desirable to use the same pencil scanning beam(s) of radiation to create transmission images. Some detectors have been proposed in previous attempts to address this need, including cavity detectors, detectors with bulk plastic scintillators acting as waveguides, and detectors utilizing wavelength-shifting fibers (WSFs) as waveguides.

### SUMMARY

Previous detectors that have been proposed to obtain transmission images from x-ray pencil beams used in backscatter imaging systems are inadequate for a variety of reasons, including being bulky even in cases of single-channel detectors, being expensive and/or difficult to manufacture, suffering from low efficiency and signal-to-noise ratios due to various effects, and sometimes being limited to a single channel.

Embodiments disclosed in this application can provide low-cost, compact, dual-energy transmission x-ray detectors optimized for use with scanning pencil beams of x-rays, as used in backscatter imaging applications. In their simplest form, embodiments include a single channel, single-energy x-ray detector that includes a scintillator screen coupled optically to a light guide for collecting the scintillation light, where the light guide need not shift the wavelength of the scintillation light. The detector may be long enough to intercept the beam over the entire angle through which the beam is swept. Embodiments described herein particularly benefit from a use of ultra-reflective optical materials including many dielectric layers of material. Multi-layer dielectric reflecting materials, when used with x-ray detectors as taught in this disclosure, make light collection possible for detectors with a long active area (for example, greater than a few feet). These materials may be highly reflective (>99%) for wavelengths above about 400 nm. A scintillator material that emits light in this highly reflective wavelength range of the reflective material may be used for good matching. The scintillator, which can include a strip of scintillator phosphor screen such as GdOS, may be optically coupled to a surface of the light guide, and the scintillation light may be read out by one or more photodetectors such as a photomultiplier tube, optically coupled to at least one end of the light guide.

When incident x-rays within a sweeping, scanning x-ray pencil beam are incident on the scintillator, some energy of the x-rays may be converted into scintillation light, which then enters the light guide. Through a combination of internal reflection and reflection from the surrounding multi-layer dielectric reflective material, the light may be efficiently detected by the photodetectors. Since the strip of scintillating phosphor, the light guide, and the reflective material are relatively inexpensive, a very efficient transmission detector with a long active length can be constructed for relatively little cost, with the cost of the PMTs being the dominant cost item. In addition, the detector can be constructed with a very compact cross section, as a light guide with a small cross-sectional dimension can be used. For example, either square or round light guides can be used with lengths of several meters, with a width of only a few centimeters.

The design of disclosed x-ray detector embodiments specially enable construction of dual-energy embodiments and/or embodiments with multiple spatial channels, allowing for higher-resolution transmission images to be obtained. These embodiments will be described in more detail hereinafter.

In one particular embodiment, an x-ray detector includes a scintillator structure that defines a scintillator volume. The scintillator volume is configured to receive incident x-rays and to convert a portion of energy from the x-rays into scintillation light. The x-ray detector also includes a light guide that is mechanically coupled to the scintillator structure directly or indirectly and is also optically coupled to the scintillator volume. The detector further includes a multi-layer dielectric reflective material at least partially surrounding the light guide and the scintillator volume. The reflective material is configured to confine the scintillation light within the light guide via reflection. Also, the x-ray detector includes a photodetector optically coupled to an end of the light guide. The light guide is configured to guide the scintillation light from the scintillator volume to the photodetector for detection of the scintillation light.

The photodetector may be a first photodetector, and the end of the light guide may be a first end. The x-ray detector may further include a second photodetector optically coupled to a second end of the light guide and configured to receive a portion of the scintillation light that is guided by the light guide. The x-rays may be part of a scanning x-ray pencil beam that can scan a target object over a scan angle, and the scintillator volume can have a length that enables the scintillator volume to receive, over an entirety of the scan angle, x-rays from the x-ray pencil beam that are transmitted through the target. Alternatively, distinct detectors may receive x-rays from the x-ray pencil beam over different portions of the scan angle.

The x-ray detector may be a multi-channel x-ray detector and further include:
a) a plurality of scintillator structures defining respective scintillator volumes configured to receive the incident x-rays and to convert respective portions of energy from the x-rays into scintillation light;
b) a plurality of light guides that are mechanically coupled to respective scintillator structures and optically coupled to respective ones of the plurality of scintillator volumes with a one-to-one correspondence; and
c) a plurality of photodetectors optically coupled to respective ends of respective ones of the plurality of light guides, the plurality of light guides being configured to guide the scintillation light from respective scintillator volumes to respective photodetectors for detection of the scintillation light from respective scintillator volumes.

The multi-channel x-ray detector may further be configured to be a multi-energy-channel x-ray detector, wherein the x-rays include relatively lower-energy x-rays and relatively higher-energy x-rays, and wherein at least one first of the scintillator volumes is a low-energy scintillator volume optimized to receive the relatively lower-energy x-rays, and wherein at least one second of the scintillator volumes is a high-energy scintillator volume that is optimized to receive the relatively higher-energy x-rays. An x-ray filter that is mechanically coupled to the structure defining the high-energy scintillator volume or arranged between the structure defining the high-energy scintillator volume and the structure defining the low-energy scintillator volume may be included. The x-ray filter may be configured to block the relatively lower-energy x-rays from being received at the high-energy scintillator volume. The low-energy and high-energy scintillator volumes may have first and second thicknesses, respectively, in a direction of incidence of the incident x-rays, and the second thickness may be greater than the first thickness. The low-energy and high-energy scintillator volumes may be formed of mutually different scintillator materials that are optimized for detecting the lower-energy x-rays and the higher-energy x-rays, respectively.

The x-ray detector may be further configured to be a multi-spatial-channel x-ray detector, with at least two of the plurality of scintillator volumes being arranged spatially to receive different spatial portions of the incident x-rays essentially simultaneously, within a time of propagation of the x-rays between the two scintillator volumes, for example. The incident x-rays may form an elliptical x-ray beam spot, and the at least two scintillator volumes may be arranged spatially with respect to each other such that both of the at least two scintillator volumes can receive portions of the elliptical x-ray beam spot essentially simultaneously. The elliptical beam may be used to provide optimized imaging resolution in two orthogonal directions.

The photodetector may be a photomultiplier tube (PMT).

A width of the scintillator volume may be smaller than a width of the light guide, both of the widths being measured in a common direction perpendicular to an angle of incidence of the incident x-rays. The scintillator volume may have length and width dimensions that are perpendicular to each other and to an angle of incidence of the incident x-rays, a length-to-width ratio being between about 10:1 and about 250:1. The length-to-width ratio may also be between about 20:1 and about 100:1 or between about 30:1 and about 60:1.

A length of the scintillator volume measured perpendicular to an angle of incidence of the incident x-rays may be between about 6 inches and about 200 inches. The length may be between about 40 inches and about 160 inches. A width of the scintillator volume measured perpendicular to an angle of incidence of the incident x-rays may be between about 0.1 inches and about 1 inch or between about 0.5 inches and about 3 inches.

The light guide may be an acrylic light guide, and/or have a circular cross-sectional profile, and/or have a rectangular cross-sectional profile such as a square profile.

The multi-layer dielectric reflective material may have a reflectivity of at least 95%, at least 98%, or at least 99% for the scintillation light.

In another embodiment, the x-ray detector described above may be part of an x-ray imaging system that includes a scanner configured to output a scanning pencil beam of x-rays toward a target object, as well as a backscatter detector configured to detect x-rays that are scattered from the target as a result of the pencil beam being incident at the target. The incident x-rays that are incident at the x-ray detector described above may be part of the pencil beam and may be received at the scintillator volume after being transmitted through the target. The x-ray imaging system may further include a processor that is configured to receive signals from the x-ray detector and to form an x-ray transmission image of the target therefrom.

In a further embodiment, a method of x-ray imaging includes receiving incident x-rays, converting a portion of energy from the x-rays into scintillation light, optically coupling the scintillation light into a light guide, reflecting the scintillation light from a multi-layer dielectric reflector to confine the scintillation within the light guide, and detecting the scintillation light at an end of the light guide.

In yet another embodiment, an x-ray detector includes means for receiving incident x-rays, means for converting a portion of energy from the x-rays into scintillation light, means for optically coupling the scintillation light into a light guide, means for reflecting the scintillation light from a multi-layer dielectric reflector to confine the scintillation within the light guide, and means for detecting the scintillation light at an end of the light guide.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a schematic diagram illustrating an embodiment x-ray detector including a multi-layer dielectric reflective material being used in an x-ray backscatter system.

FIG. 1B is a schematic diagram illustrating elements of FIG. 1A that can form part of an embodiment system for x-ray scanning.

FIG. 2A is a cross-sectional view through a single-channel embodiment of the x-ray detector.

FIG. 2B is a cross-sectional view through a single-channel embodiment of the x-ray detector similar to that of FIG. 2A but with a narrower scintillator material for increased resolution relative to FIG. 2A.

FIG. 3 is a schematic illustration of the single-channel x-ray detector of FIG. 2A without the multi-channel dielectric reflector material.

FIG. 4A is a cross-sectional view through a dual-spatial-channel embodiment of the detector with left and right channels for obtaining two simultaneous scan lines of image data.

FIG. 4B is a cross-sectional view through a dual-spatial channel embodiment of the x-ray detector with left and right channels for obtaining two simultaneous scan lines of image data with the same image resolution as FIG. 4A but using smaller light guides.

FIG. 5 is a schematic illustration of the dual-spatial channel embodiment of FIG. 4B without the multi-layer dielectric reflector material.

FIG. 6 is a cross-sectional view through a dual-spatial-channel, dual-energy-channel (i.e., four-channel total) embodiment of the x-ray detector, wherein the four channels may be referred to as left and right dual-energy channels.

FIG. 7 is a schematic illustration of the four-channel embodiment of FIG. 6.

FIG. 8 is a plan view of an x-ray beam with an elliptical beam spot intersecting with scintillator structures of a dual-spatial-channel x-ray detector embodiment to optimize resolution along the width and length directions of the x-ray detector.

FIG. 9 is a perspective-view illustration of an embodiment x-ray detector using cylindrical light guides configured for dual-spatial-channel, dual-energy channel operation in a compact, support-bracket-secured assembly.

FIG. 10 is a cross-sectional view illustration of the embodiment x-ray detector of FIG. 9.

FIG. 11 is a perspective-view illustration of the embodiment x-ray detector of FIG. 9, showing an entire x-ray detector assembly with photomultiplier tubes.

FIG. 12 is a graph illustrating reflectivity as a function of scintillation light wavelength and incident angle for an example multi-layer dielectric refractive material that may be a used in embodiments.

FIG. 13 (prior art) is a schematic illustration of an existing detection apparatus that utilizes multiple PMTs coupled to a hollow optical cavity, with no light guide.

FIG. 14 (prior art) is a schematic illustration of an existing x-ray detection apparatus that employs a cylindrical plastic scintillator volume that also functions as a light guide.

FIG. 15 (prior art) is a schematic illustration of an existing x-ray detection apparatus that employs a bundle of wavelength-shifting fibers (WSFs).

FIG. 16 is a flow diagram illustrating an embodiment procedure for detecting x-rays, which may include using an embodiment x-ray detector.

### DETAILED DESCRIPTION

A description of example embodiments follows.

The teachings of all patents, published applications and references cited herein are incorporated by reference in their entirety.

Unlike a fan beam that can use a segmented array of detector elements on the far side of the target object to create a transmission image, a pencil beam of radiation, as used in a backscatter x-ray imaging system, typically requires the use of a large monolithic scintillating medium on the far side of the object to intercept the beam. For example, in drive-through backscatter x-ray portals, a long length of plastic scintillator has been used as a transmission detector to detect x-rays transmitted through the object in one or more of the x-ray views.

Dual-energy versions of these large monolithic detectors have also been proposed, wherein wavelength-shifting fibers are used to read out the scintillator. In the first referenced patent, two separated channels of scintillating medium are read out using wavelength-shifting fibers to collect the scintillation light and direct it onto the photocathode of a Photo-Multiplier Tube (PMT). The first scintillation medium is placed closest to the x-ray source and is sensitive to the lower-energy x-rays in the transmitted beam. A second scintillation medium is placed so that it can intercept the x-rays transmitted through the first medium and is sensitive to the higher-energy x-rays in the transmitted beam. A filter material can be placed between the two media to enhance the detector's ability to perform spectral discrimination, and therefore improve the material-discrimination capability of the imaging system. In the second patent, the scintillation light from the first scintillation medium is collected with wavelength-shifting fibers (WSF), and the scintillation light from the second scintillation medium is read out by some other means, for example, a non-wavelength-shifting light guide, such as a piece of plastic scintillator (which acts as both the scintillator and the light guide).

Each of these detector designs has advantages and disadvantages. WSF implementation on both the low and high-energy channels leads to a compact, low profile design, but this tends to be an expensive approach as the fibers are costly. The use of plastic scintillator in the high-energy channel of the second design leads to a larger, less-compact detector. The existing detector designs include many disadvantages, which are described hereinafter more particularly in connection with FIGS. 13-15.

In contrast to existing x-ray detectors, embodiments described herein take advantage of multi-layer dielectric reflecting materials, which can be used to enhance operation of a waveguide for collecting scintillation light, such that performance exceeds that of wavelength shifting fiber (WSF) designs in terms of light collection efficiency and signal-to-noise ratio, even while being much less costly and much easier to manufacture, with much greater design flexibility.

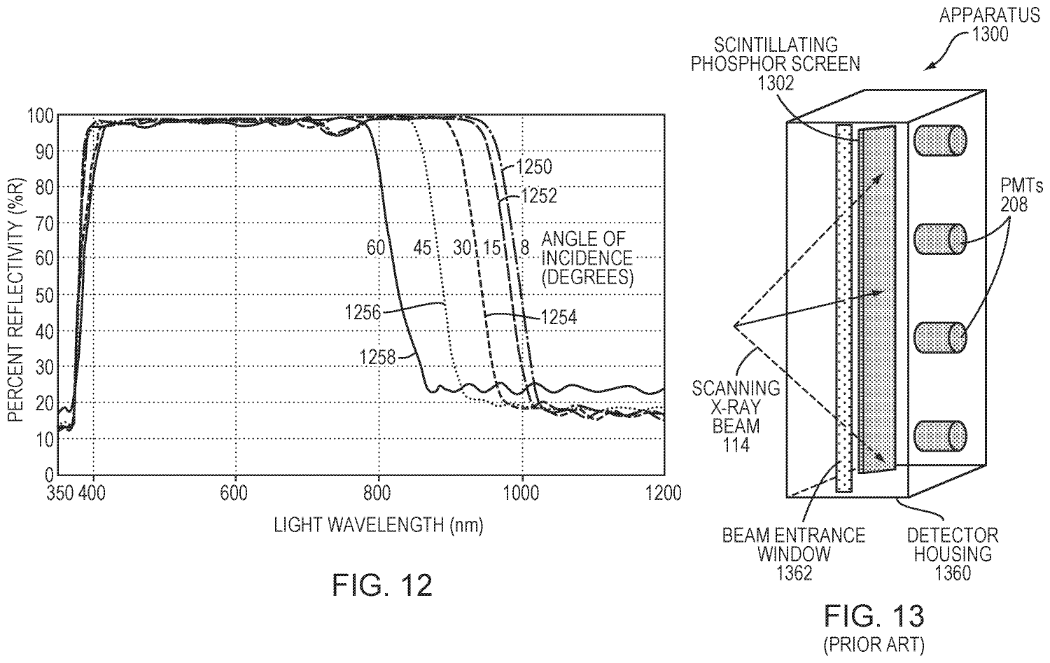

Embodiments described herein, using multi-layer dielectric reflecting materials, enable a wide variety of detector designs that can be used for transmission imaging using a pencil beam of x-rays produced by an x-ray backscatter imaging system. For example, light collection is possible for detectors with a very long active area, such as greater than a few feet, for example. Multi-layer dielectric reflecting materials can be highly reflective, such as having reflectivities greater than 95%, greater than 98%, or greater than 99% for wavelengths above about 400 nm. These high reflectivities can also be maintained over a wide range of angles of incidence of the scintillation light with respect to the reflective surface, as illustrated in FIG. 12, for example.

An example scintillator material that is well matched to this reflective material is GdOS, with a peak emission wavelength of 511 nm. Accordingly, GdOS is an example of a scintillator material that can be used in embodiment x-ray detectors described herein.

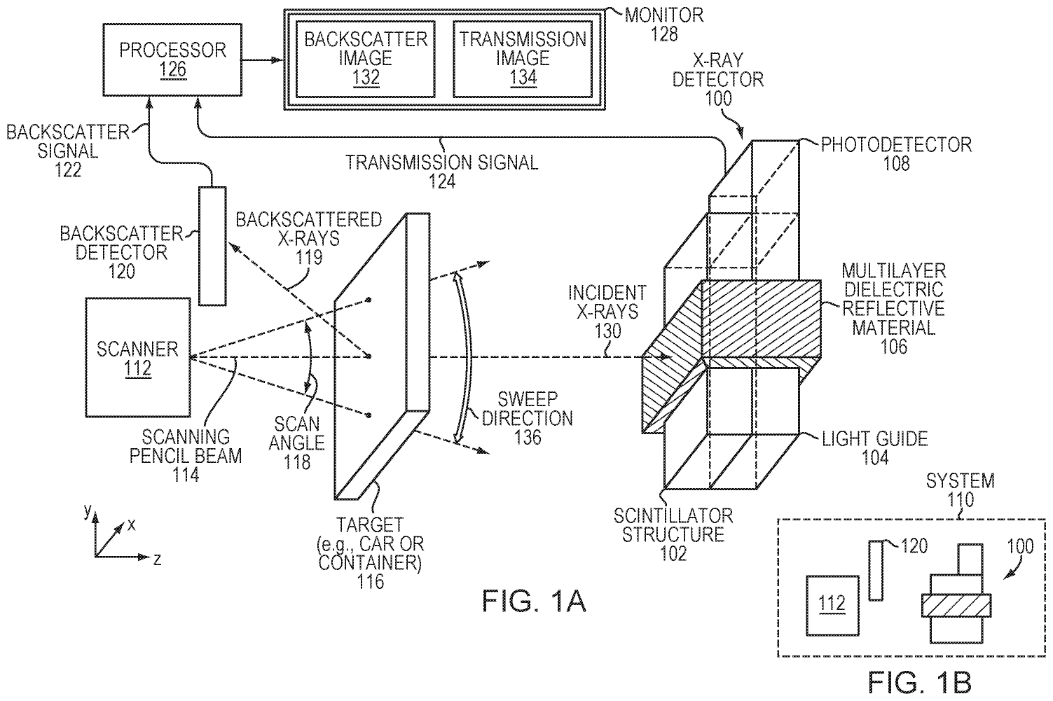

FIG. 1A is a schematic diagram of an embodiment x-ray detector 100. The detector 100 includes a scintillator structure 102 that defines therein a scintillator volume that is configured to receive incident x-rays 130 and to convert a portion of energy from the x-rays 130 into scintillation light. The x-ray detector 100 also includes a light guide 104 that is mechanically coupled to the scintillator structure 102 and optically coupled to the scintillator volume defined by the structure 102. The mechanical coupling between the light guide 104 and the scintillator structure 102 may be direct coupling or indirect coupling. Direct coupling may include bonding with an adhesive, bolting, or otherwise fastening the structure 102 and the light guide 104 to each other directly so that they are in contact. Indirect mechanical coupling may be by means of a connecting bracket or optically transmissive intermediate layer, such as optical grease, for example (not illustrated in FIG. 1A.). As used herein, the light guide 104 is considered to be “optically coupled” to the scintillator structure 102 when some of the scintillation light that is produced within the scintillator volume can be received within the light guide 104.

The x-ray detector 100 also includes a multi-layer dielectric reflective material 106 that at least partially surrounds the light guide 104 and the scintillator volume defined by the scintillator structure 102. The reflective material 106 is configured to confine the scintillation light within the light guide via reflection. In one example, the multi-layer dielectric reflective material 106 can include the Enhanced Specular Reflector “Vikuiti™” dielectric reflector material from 3M, reflectivity of which is illustrated in FIG. 12.

FIG. 1A illustrates the multi-layer dielectric reflective material 106 covering only a portion of the light guide 104 and scintillator structure 102. However, as will be understood by those skilled in the art in view of this description, it is preferable for the reflective material 106 to cover most or all of the light guide 104 and scintillator structure 102, such as surrounding the light guide 104 and scintillator structure 102 around an entire perimeter thereof, from one end to the other end. In this manner, any scintillation light that exits the light guide 104 will likely be reflected from the reflective material 106 and re-enter the light guide 104, and the scintillation light will be encouraged to continue to propagate within the light guide 104 toward the photodetector 108. Furthermore, where the multi-layer dielectric reflective material 106 surrounds the scintillator structure 102, scintillation light that is produced by the structure 102 but initially emitted in a direction other than to intersect with the light guide 104 may be reflected back toward the light guide 104, increased optical coupling of the scintillation light into the light guide 104.

A major disadvantage of WSF-based x-ray detectors, such as that illustrated in FIG. 15, is that the WSF fibers must be limited in diameter in order to achieve both their mechanical and optical properties. For this reason, since the diameter of the WSF fibers must be limited, consequently an entire array of these fibers must be used in order to provide an adequate signal to be detected from the scintillation light, increasing cost and manufacturing complexity.

Significantly, by virtue of embodiment x-ray detectors described herein using a multi-layer dielectric reflective material, reflection at surfaces of the light guide 104 can be so high that even after many reflections from interior surfaces of the light guide 104, a substantial scintillation light signal can remain to be detected at an end of the light guide 104. As will be understood in view of this specification, the larger the interior dimensions of the light guide 104, the more effective the light guide 104 can be in confining the light, because fewer reflections from interior surfaces of the light guide 104 are required to traverse a given distance from scintillation light being introduced into the light guide 104 to the scintillation light being detected at an end of the light guide 104. As such, this construction enables very flexible design, a simplified manufacturing, and better confinement performance for scintillation light for increased signal-to-noise ratio compared with the prior art designs of FIGS. 13-15.

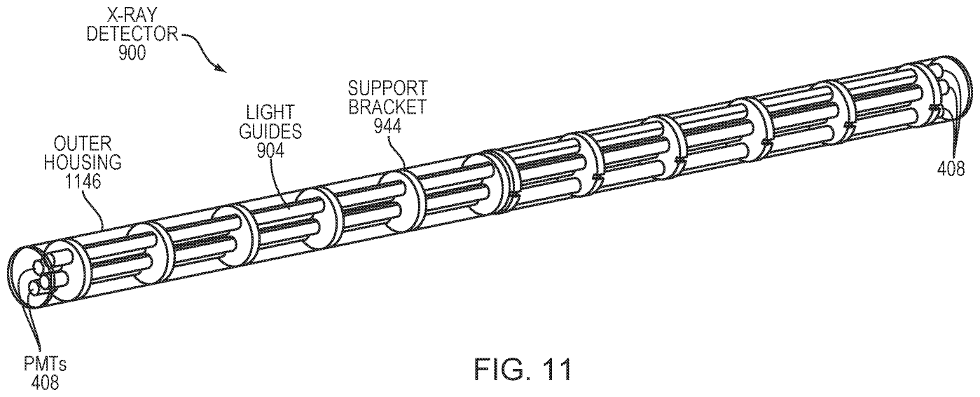

The x-ray detector 100 also includes a photodetector 108 that is optically coupled to an end of the light guide 104. The light guide 104, thus, is configured to guide the scintillation light from the scintillator volume defined by the structure 102 to the photodetector 108 for detection of the scintillation light. An end of the light guide 104 that is opposite an end where the photodetector 108 is coupled may include a mirror (not illustrated in FIG. 1A), in order to reflect scintillation light back toward the photodetector 108. Alternatively, a second photodetector, similar to the photodetector 108, may be optically coupled to the second end of the light guide 104 and configured to receive a portion of the scintillation light that is guided by the light guide 104. As will be understood by those skilled in the art, signals from two such photodetectors may be combined if desired to improve signal-to-noise ratio. An example embodiment including photodetectors at both ends of a light guide is illustrated in FIG. 11, for example.

The multi-layer dielectric reflective material 106 enables a significant fraction of the scintillation light produced by the scintillator volume to be transported down the length of the light guide 104.

FIG. 1A further illustrates a scanning environment where use of the x-ray detector 100 is particularly advantageous. A scanning system illustrated in FIG. 1A is designed to perform backscatter x-ray imaging, as well as to obtain a transmission image during the same scan from the same scanning beam. A scanner 112 is configured to output a scanning pencil beam 114 of x-rays toward a target 116. The target 116 may be a car, a truck, a shipping container, or the like, or any other object of which an x-ray image is sought. The scanner 112 may include a disk chopper wheel configuration, a drum chopper wheel configuration, or any other configuration that can produce the scanning pencil beam 114, which oscillates over a scan angle 118, with a sweep direction 136, in order to scan the target 116 from top to bottom (or side to side) The scanning pencil beam 114 is swept in a plane that is parallel to the y-z plane illustrated in FIG. 1A.

The incident x-rays 130 that are incident at the scintillator volume of the x-ray detector 100 are part of the scanning pencil beam 114 and are transmitted through the target 116. Advantageously, using the multi-layer dielectric reflective material 106, embodiments can be built easily and inexpensively such that the scintillator volume can have a length enabling the scintillator volume to receive, over an entirety of the scan angle 118, incident x-rays 130 from the scanning x-ray pencil beam 114 that are transmitted through the target. A length of the scintillator volume is illustrated in FIG. 8, for example, and may be measured in a direction parallel to the y-axis illustrated in FIG. 1A. However, it should also be understood that it is not a requirement for embodiment devices to be able to receive x-rays 130 over the entire scan angle 118. Furthermore, in some embodiments, while less preferred, scintillation, light guiding, and detection functions are segmented by different detectors or channels across a given sweep 136 over the scan angle 118.

The system illustrated in FIG. 1A includes a backscatter detector 120 that is configured to detect x-rays 119 that are backscattered from the target 116 as a result of the pencil beam 114 being incident at the target 116. The backscatter detector 120 can output a backscatter signal 122 (via, e.g., a PMT or other photodetector, not illustrated in FIG. 1A) to a processor 126. The processor 126 may process the backscatter signal 122 in order to produce a backscatter image 132 of the target 116 at a monitor 128, for example. As will be understood by those skilled in the art of x-ray backscatter imaging, the target 116 may be translated with respect to the scanner 112 and the x-ray detector 100 in order to obtain an image of the entire target 116. Alternatively, the target 116 may remain stationary, while the scanner 112 and x-ray detector 100 are translated synchronously such that the scanning pencil beam 114 can be swept over the target 116 to the full 2D extent that it is to be imaged.

At the same time that the backscatter image 132 is obtained, a transmission image 134 of the target 116 may also be obtained. The photodetector 108 may output a transmission signal 124 to the processor 126, for example. The processor 126 may produce the transmission image 134 at the monitor 128. The backscatter image 132 and transmission image 134 are illustrated side-by-side on the monitor 128 to reinforce the fact that the system illustrated in FIG. 1A may obtain both of these images during a single scan of the target 116.

As will be understood in view of this description, the incident x-rays 130 may be received from other sources besides the scanning pencil beam 114. Nonetheless, as already described, embodiment x-ray detectors such as the x-ray detector 100 are particularly well-suited for obtaining transmission images using a scanning pencil beam such as that used in a backscatter x-ray imaging system. Accordingly, “scanning pencil beam,” “pencil beam,” and “incident x-rays” may be used interchangeably hereinafter.

FIG. 1B is a schematic illustration of a system 110 that includes fewer components than the system illustrated in FIG. 1A. In particular, the system 110 illustrated in FIG. 1B includes the scanner 112, the backscatter detector 120, and the x-ray detector 100.

Because of the flexibility afforded by use of the multi-layer dielectric reflective material 106, various embodiment detectors may have a wide variety of different configurations that can be manufactured with substantial ease and minimal expense to provide high performance. For example, the x-ray detector 100 may be modified to be a multi-channel x-ray detector. A plurality of scintillator structures 102 defining respective scintillator volumes that are configured to receive the incident x-rays 130 and to convert respective portions of energy from the x-rays 130 into scintillation light may be provided.

Further, a corresponding plurality of light guides 104 may be mechanically coupled to respective scintillator structures and optically coupled to respective ones of the plurality of scintillator volumes, and these may have a one-to-one correspondence, for example. Each light guide may be a dedicated light guide that guides the scintillation light exclusively from one corresponding, respective scintillator volume, such that light from a given scintillator volume is coupled only to the one light guide. For any other light guides and scintillator volumes in an embodiment device having multiple detector channels, there may similarly be a one-to-one correspondence between scintillator structures and light guides.

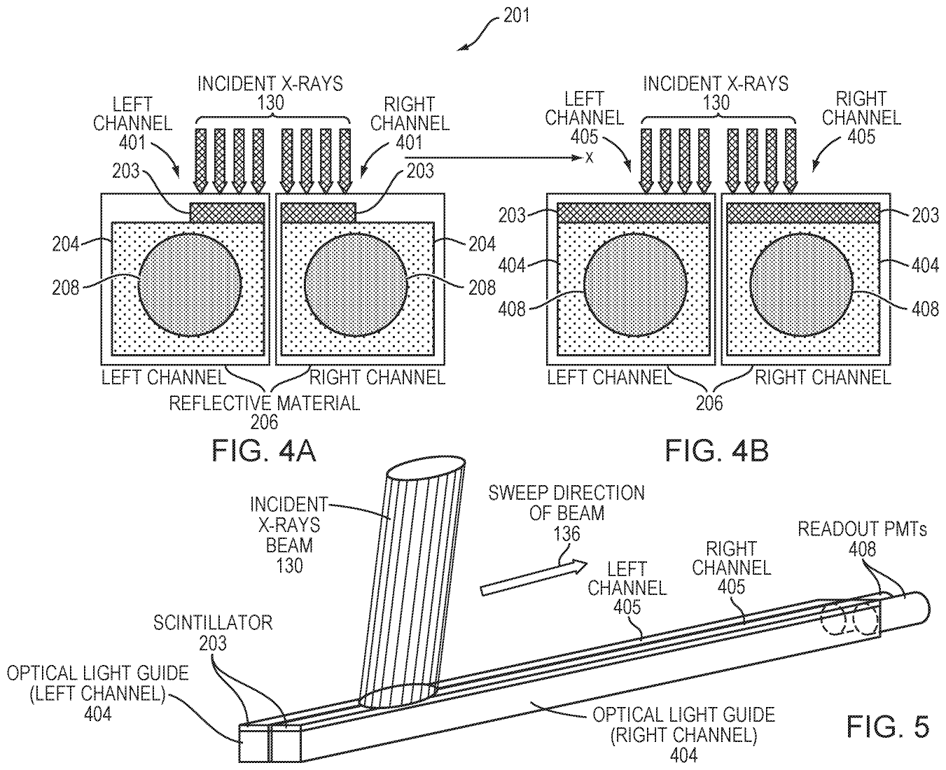

A plurality of photodetectors 108 may be optically coupled to respective light guides of the plurality of light guides 104, and the plurality of light guides 104 may be configured to guide the scintillation light from respective scintillator volumes to respective photodetectors for detection of the scintillation light from respective scintillator volumes. Various examples of such embodiment x-ray detectors are illustrated in FIGS. 4A-4B and 5-11, for example.

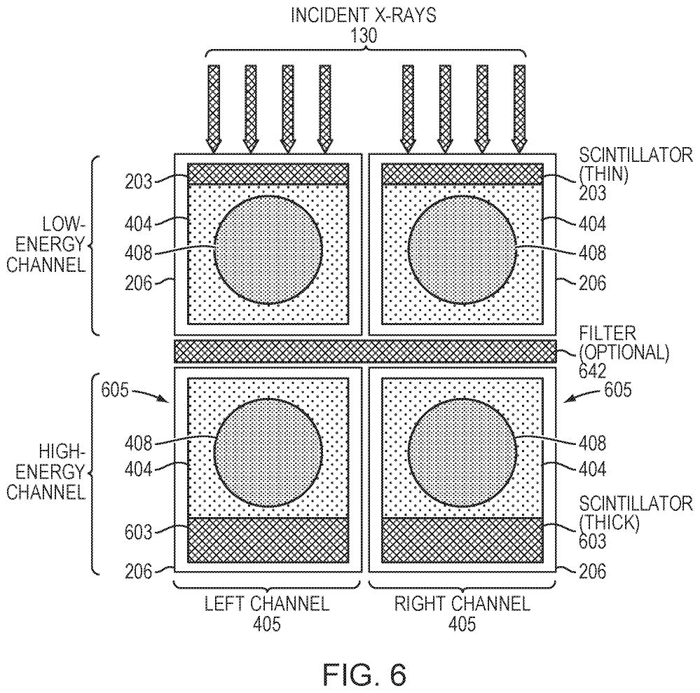

More particularly, an x-ray detector according to an embodiment may be configured to be a multi-spatial channel x-ray detector. At least two of the plurality of scintillator volumes may be arranged spatially to receive different spatial portions of the incident x-rays. The different spatial portions of the incident x-rays may be received essentially simultaneously by the two scintillator volumes, within the limits of a propagation time of the incident x-rays between the two scintillator volumes. Example multi-spatial channel x-ray detectors with this arrangement are illustrated in FIGS. 4A-4B, 5, and 8, for example. Furthermore, various example embodiments, such as those illustrated in FIGS. 6-7 and 9-11, include multiple spatial channels, as well as multiple energy channels. Resolution may be further improved by use of an elliptical x-ray beam spot formed by the scanning x-ray pencil beam, as further described in relation to FIG. 8, for example.

Likewise, the embodiment x-ray detector 100 may be modified to be a multi-energy channel x-ray detector. X-rays 130 that are incident at the scintillator volume may include relatively lower energy x-rays and relatively higher energy x-rays, in a spectrum. At least one of the scintillator of the multiple scintillator volumes noted above may be a low-energy scintillator volume that is optimized to receive the relatively lower energy x-rays. In similar fashion, at least one of the multiple scintillator volumes may be a high-energy scintillator volume that is optimized to receive the relatively higher energy x-rays. In this manner, additional imaging information may be obtained. Example x-ray detector embodiments that are configured for separate low-energy and high-energy x-ray detection are illustrated and described in connection with FIGS. 6-7 and 9-11, for example.

In these embodiments with multiple energy channels, an x-ray filter may be optionally used. The x-ray filter may be mechanically coupled to the structure defining the high-energy scintillator volume, as illustrated in FIGS. 6 and 9-10, for example. Alternatively, the x-ray filter may be arranged between the structure defining the high-energy scintillator volume and the structure defining the low-energy scintillator volume, with the x-ray filter, in either configuration, being configured to block the relatively lower energy x-rays from being received at the high-energy scintillator volume. In addition, or as an alternative to using an x-ray filter to obtain spectral separation of the x-rays, the low-energy and high-energy scintillator volumes may have first and second thicknesses, respectively, in a direction of incidence of the incident x-rays, and the second thickness may be greater than the first thickness, as illustrated in FIG. 6, for example. As yet another alternative, or in addition to the other configurations to achieve x-ray energy separation, the low-energy and high-energy scintillator volumes may be formed of mutually different scintillator materials that are optimized for detecting the lower energy x-rays and higher energy x-rays, respectively.

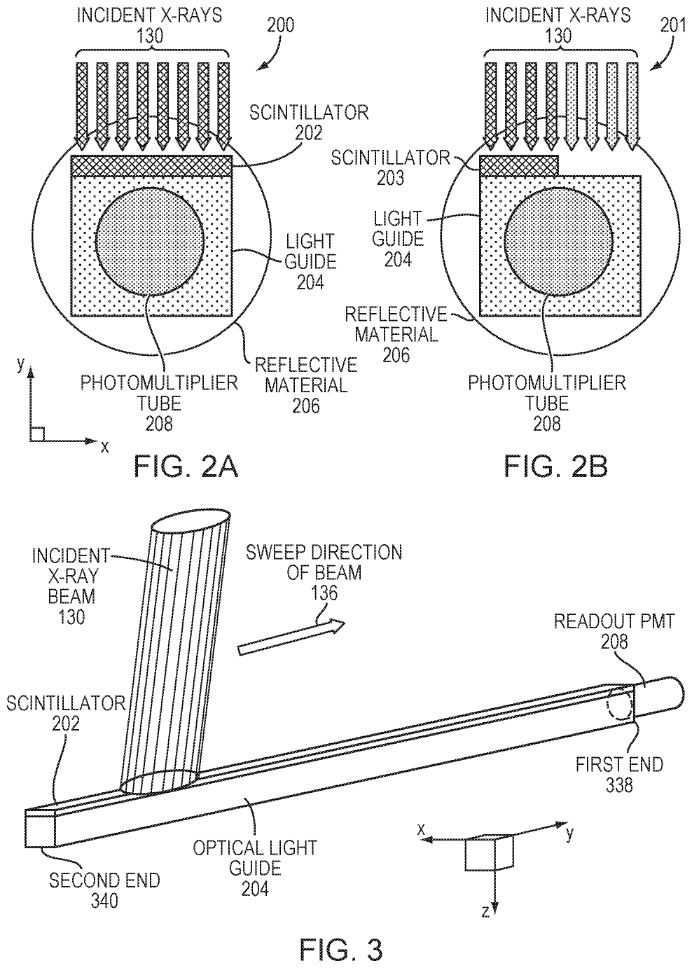

FIG. 2A is a cross-sectional view through a single-channel embodiment x-ray detector 200. The detector 200 includes a scintillator 202, a light guide 204, reflective material 206, and a photomultiplier tube (PMT) 208, all of which perform functions analogous to those described in relation to the x-ray detector 100 of FIG. 1A.

In FIG. 2A, the reflective material 206 is shown surrounding the entire light guide 204 and scintillator structure 202. The scintillator structure 202, which can include a strip of scintillator phosphorous screen such as GdOS, is optically coupled to the top surface of the light guide 204 as illustrated in FIG. 2A. The scintillation light is read out by one or more photodetectors such as a photomultiplier tube, optically coupled to at least one end of the light guide. The scintillation material in FIG. 2A is shown covering the entire top surface of the light guide, so that it intercepts the full width of the incident x-ray beam. The incident x-rays contained in the sweeping beam are incident on the scintillator from the top of the figure. The scintillation light produced in the scintillator volume defined by the scintillator structure 202 is read out by the PMT 208. It should be understood that other types of the photodetectors 108 described in FIG. 1A may be used. Nonetheless, PMT photodetectors 208 can be particularly effective for use in embodiment detectors.

The PMT 208 is optically coupled to one end of the light guide 204. The incident x-rays 130, which are understood to be part of the sweeping x-ray beam (scanning pencil beam) 114 in FIG. 1A, are incident on the scintillator structure 202 and the scintillation volume defined thereby from the top of the FIG. 2A. Some energy of the incident x-rays 130 is thereby converted into scintillation light, which then enters the light guide 204. Through a combination of internal reflection and reflection from the surrounding reflective material 206, the scintillation light can be detected by the PMT 208.

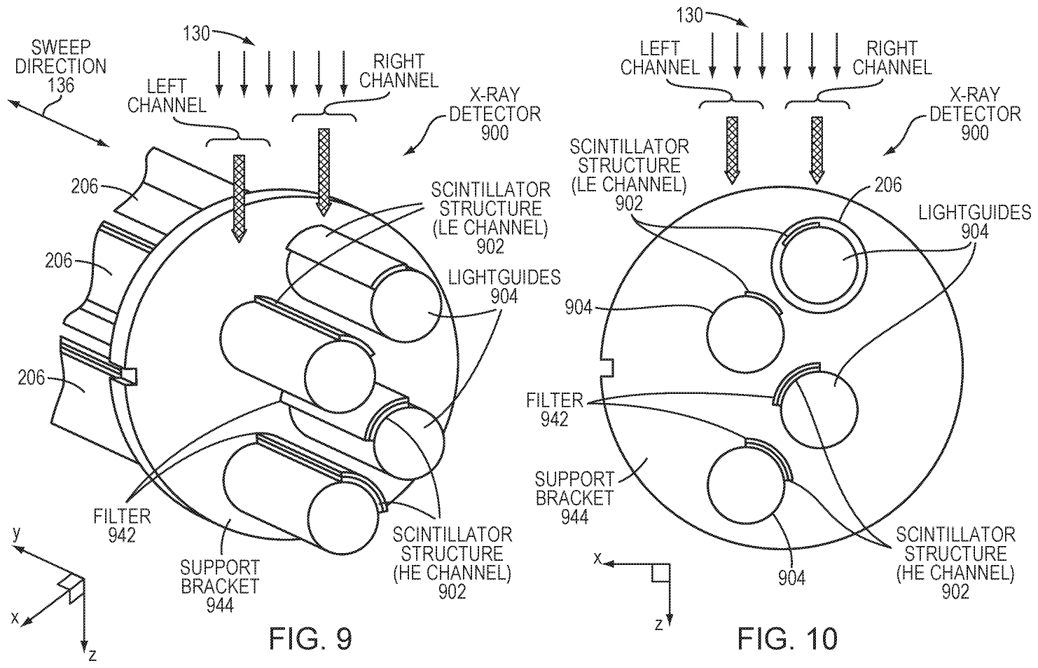

Since the strip of scintillating phosphor (scintillator structure) 202, the light guide 204, and the reflective material 206 are relatively inexpensive, a very efficient transmission detector with a long active length can be constructed for relatively little cost, with the cost of the PMT 208 being the dominant cost item. In addition, the detector 200 can be constructed with a very compact cross-section, since a light guide 204 with a small cross-sectional dimension can be used. For example, either square light guides, as illustrated in FIG. 2A, or other rectangular light guides, or round light guides, as illustrated in FIGS. 9-11, for example, can be used with lengths of several meters and widths of only a few centimeters, for example. Lengths and widths are further described in relation to FIG. 8 with greater specificity.

FIG. 2B is a cross-sectional view through a single-channel embodiment x-ray detector 201 similar to that of FIG. 2A but with a narrower scintillator structure for increased resolution relative to FIG. 2A. In FIG. 2B, a scintillator structure 203 covers about half of the top surface of the light guide 204. Since the resolution of a transmission imaging system that uses a sweeping pencil beam is determined by only the part of the x-ray beam that is detected, the resolution in the x-direction of the transmission image created with the x-ray detector 201 will be about twice that of the image created with the x-ray detector on the left, because the width of the detected portion of the beam is about half that of the left detector. This allows the resolution of the x-ray detector to be adjusted, simply by changing the width of the scintillator strip.

FIG. 3 is a schematic illustration of the single-channel x-ray detector of FIG. 2A without the multi-channel dielectric reflector material 206. FIG. 3 also illustrates that the light guide 204 has a first end 338 and a second end 340. The PMT 208 is optically coupled to the first end 338. However, as will be understood, a second PMT or other photodetector may be optically coupled to the second end 340 to receive a portion of the scintillation light that is guided by the light guide 204. In similar manner, any of the other embodiments described herein may be so modified, such that photodetectors such as PMTs may be provided at both ends of the light guide. Furthermore, in some embodiments, multiple photodetectors may be employed at each end of the light guide.

FIG. 4A is a cross-sectional view through a dual-spatial-channel embodiment detector 401-201 with two spatial channels referred to as a “left channel” 401 and a “right channel” 201, respectively, for obtaining two simultaneous scan lines of image data. The width of the scintillator structures 203 have been reduced to increase the resolution of each detector channel. The two channels provide two independent channels of image data for each sweep of the incident x-ray beam. This configuration makes more effective use of the x-ray beam than the detector 201, as the full width of the beam is now used to create the image, with two lines of image data formed, each with resolution similar to that of the x-ray detector shown in FIG. 2B.

FIG. 4B is a cross-sectional view through another dual-spatial channel embodiment of the x-ray detector 405-405 with a left channel 405 and a right channel 405, also for obtaining two simultaneous scan lines of image data. Light guides 404 and PMTs 408 of the x-ray detector 405-405 have smaller profiles than the light guides 204 and PMTs 208 of FIG. 4A, respectively, and are more commensurate in widths with the scintillator structures 203 than in FIG. 4A.

In FIG. 4B, the detector 405-405 configuration would produce resolution similar to that in FIG. 4A. While the x-ray detector configuration in FIG. 4B would appear to be advantageous because it uses light guides of smaller cross section and is therefore smaller and more compact, it also requires many more reflections of the scintillation light along its length before the light reaches a photodetector. Depending on the efficiency of the light guide and reflective material, this can greatly lower the light collection efficiency. Thus, the configuration shown on the left, while larger, may be more effective operationally.

FIG. 5 is a schematic illustration of the dual-spatial channel embodiment detector 405-405 of FIG. 4B, but without the multi-layer dielectric reflector material to improve visualization of the figure. In view of this disclosure, it will be understood by those skilled in the art that any number of spatial channels can be utilized, so long as the beam is sufficiently wide to illuminate all the parallel detector channels.

The embodiments described in relation to FIGS. 1A-5 are either single-spatial-channel or multi-channel, single-energy detectors. However, by placing a second detector channel behind the first so that x-rays passing through the first detector channel are incident on the second detector channel, a detector with x-ray energy (spectral) discrimination can be constructed. The x-ray detector upon which the beam is first incident may optimized to preferentially detect lower energy x-rays (called the “low-energy” channel) while the second detector may be optimized to detect higher energy x-rays preferentially (called the “high-energy” channel).

One approach to this optimization is to use the same scintillator such as GdOS on both low and high energy channels, but to use a thinner scintillator strip on the low-energy channel so that it only effectively absorbs the low energy x-rays and to use a thicker scintillator strip on the high-energy channel so that it is more efficient at absorbing the higher-energy x-rays. An example is to use an 80 mg/cm² GdOS scintillator structure on the low-energy channel and a 250 mg/cm² GdOS scintillator structure on the high-energy channel. Alternatively, different types of scintillator material can be used on the low- and high-energy channels, and a combination of differing types and thicknesses of scintillator structures is also within the scope of embodiments. Although the low-energy channel naturally filters out some of the lower-energy x-rays before they can reach the high-energy channel, the spectral discrimination of the x-ray detector can be enhanced by adding an optional filter such as 0.25 mm to 2 mm thick copper, between the low and high energy channels.

Those skilled in the art know that such a detector is then able to provide the operator with material discrimination. X-rays transmitted though high-Z materials such as steel have fewer low-energy x-rays remaining in the beam than x-rays passing through organic materials, such as water or plastic. By analyzing the relative ratio of detector signals in the low and high energy channels, material discrimination can be performed. This is typically indicated to the operator by applying a color pallet to the image: orange for organic materials with low effective atomic number (Z), green for intermediate-Z materials such as Aluminum, and blue for higher-Z materials such as steel.

FIG. 6 is a cross-sectional view through a dual-spatial-channel, dual-energy-channel (i.e., four-channel total) embodiment x-ray detector 405-605-405-605, wherein the four channels may be referred to as left and right dual-energy channels 405-605 and 405-605. In this embodiment, the scintillator strip structure 203 of other embodiments has been used, and the strip 203 is thinner and may be applied in the low energy channel. Thicker scintillator strip structures 603 have been used in the high-energy channel 605. An optional x-ray filter 642 is also shown, and this can be used to enhance the spectral discrimination, and therefore the material discrimination of the x-ray detector. It should be noted that the high-energy scintillator structures 603 can also be mounted to the top of the light guides 404 shown in FIG. 6.

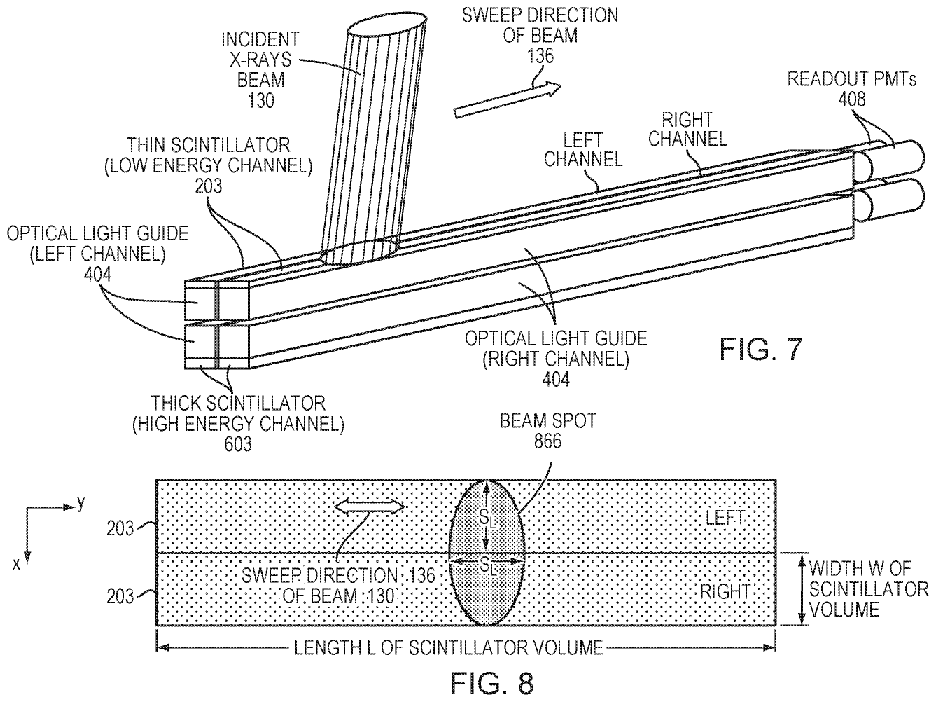

FIG. 7 is a schematic, perspective-view illustration of the four-channel x-ray detector 405-605-405-605 of FIG. 6, but without the multi-layer dielectric reflective material 206 in order to enhance visualization. The detector of FIGS. 6-7 has two (left and right) dual-energy spatial channels 405-605 and 405-605, providing two lines of dual energy transmission image data for each sweep of the incident x-ray beam. The detector of FIGS. 6-7 may be used advantageously, for example, in a drive-through backscatter portal so that two dual-energy lines of transmission data may be created for each line of backscatter detector data. The spatial resolution of the x-ray detector along the x-direction (i.e. along the drive-through direction of the vehicle through the portal) can be improved further by reducing the widths of the scintillator strip structures on the light guides, as described previously in connection with FIG. 4A.

FIG. 8 is a plan view of an elliptical beam spot 866 formed by an x-ray pencil beam intersecting with the scintillator structures 203 of a dual-spatial-channel x-ray detector embodiment such as the 405-405 detector of FIG. 4B. The elliptical beam spot may be obtained by shaping the x-ray pencil beam 114 appropriately, for example. This shape can optimize resolution along the width and length directions of an x-ray detector. As used herein, “elliptical” should be understood broadly to encompass any beam spot that is non-circular and is relatively elongated, compared with a circular beam spot, in the direction along the x-ray detector width and that is relatively shortened, compared with the circular beam spot, along the direction of the x-ray detector length L.

The resolution along the sweep direction 136 (y direction shown in FIG. 8) of the beam cannot be improved by using a different detector configuration. However, an elliptical beam profile can be used that is elongated in the direction along the x-ray detector width W (x direction shown in FIG. 8) and that is shortened along the direction of the x-ray detector length L (y direction). In this way, resolution can be optimized in both directions without decreasing the cross-sectional area of the beam (and therefore the intensity of x-rays in it), with the left and right channels increasing the resolution along the x-ray detector width and the shortened dimension of the beam spot increasing the resolution along the direction of the x-ray detector length.

In one embodiment, cylindrical acrylic light guides having circular cross-sectional profiles, lengths of 60 inches, and diameters of 1.25 inches may be used. In this example case, the length-to-width ratio is about 48:1. In another embodiment, 120″ long cylindrical light guides may be used for some applications with the same diameters of 1.25 inches, such that the length-to-width ratio is 96:1.

In FIG. 8, the x-ray pencil beam spot 866 with an elliptical profile is incident on a dual-spatial-channel detector with left and right scintillator structures 203, 203, as indicated above. The cross-sectional shape of the elliptical beam incident on the x-ray detector is optimized so that the dimension of the beam along the x-ray detector length is approximately half the dimension of the beam along the x-ray detector width. This means that the pixel resolution in each of the two image lines acquired with the left and right channels will be equal in the scan direction (x) and along the image line (y), yielding pixels that correspond to approximately square regions in the scanned object, i.e. SW SL.

FIG. 9 is a perspective-view illustration of an embodiment x-ray detector 900 that is configured for dual-spatial-channel, dual-energy-channel operation in a compact, support-bracket-secured assembly. The x-ray detector 900 includes four total detector channels. The detector 900 is configured, through the lower-energy channels, to detect lower-energy x-rays at both left channel and right spatial channels, and to detect higher energy x-rays in the left and right spatial channels, similar to the detector 405-605-405-605 of FIG. 6, for example.

However, the light guides 904 and other respective components are staggered vertically with respect to each other in the z direction illustrated in FIGS. 9-10. This facilitates mounting the photodetectors at the end of the lightguides, as typically the radius of the photodetector must exceed that of the lightguide to optimize light coupling between the guide and the photodetector, and without staggering they would interfere with one another. Further, the x-ray detector 900 includes light guides 904 that are circular in their cross-sectional profiles. Scintillator structures 902 that are applied to each of the light guides 904 are contoured to fit around the circular light guides 904. This is especially advantageous, as the effective thickness along the direction of incidence of the incident x-rays is increased compared with the scintillation volumes 203 and 603 shown in FIG. 6 (for example), resulting in increased efficiency of conversion of the x-rays into scintillation light. Also, the x-ray detector 900 includes filters 942 applied to the high-energy channels, where the filters 942 are also contoured to fit appropriately around the light guides 904 and scintillator structures 902.

The four detector channels included in the x-ray detector 900 are held in the cross-sectional orientation securely by a support bracket 944. As illustrated more fully in FIG. 11, there are multiple support brackets 944 along the y direction in order to secure the detector channels with respect to each other. As in the other embodiments, multi-layer dielectric material is used as a reflective wrap around each of the cylindrical light guides and scintillator volumes.

FIG. 10 is a cross-sectional illustration of the x-ray detector 900 of FIG. 9. In the low-energy, right-channel detector, multi-layer dielectric material 206 is illustrated encompassing the light guide 904 and scintillator structure 902. While not shown in FIG. 10, it should be understood that the multi-layer dielectric reflector material 206 is advantageously applied to each of the detector channels to surround, at least partially, the light guide and the scintillator volume for efficient conveyance of scintillator light to respective PMTs 408, which are illustrated in FIG. 11.

FIG. 11 is a perspective-view illustration of the entire x-ray detector 900, all of which is encompassed by an outer housing 1146. FIG. 11 further exemplifies how PMT detectors 408, or other photodetectors, may be optically coupled to both first and second ends of the light guides 904. It should be understood that any of the embodiments illustrated in other drawings may be so modified to include detectors at both ends of each detector channel.

FIG. 12 is a graph illustrating percent reflectivity as a function of scintillator light wavelengths and angle of incidence of scintillator light beam incident at a surface of the example multi-layer dielectric reflector material noted above. A curve 1250 illustrates the reflectivity for an angle of incidence of 8°, while a curve 1252 illustrates the reflectivity as a function of wavelength for the angle of incidence 15°. Further, curves 1254, 1256, and 1258 illustrate the reflectance as a function of scintillator light wavelength for angles of incidence of 30°, 45°, and 60°, respectively. This is the reflectivity graph for the “Vikuiti™” dielectric reflector material from 3M. These graphs illustrate that over a broad range of angles of incidence, reflectivity of the example material remains close to 98%. These very high reflectivities enable the synergistic effects for embodiment x-ray detectors described hereinabove. Notably, there is flexibility in light guide size, and larger sizes not only provide ease of manufacturing and greater flexibility of design and less expensive materials, but also improve performance and signal-to-noise ratio by increasing the amount of scintillation light that can be coupled to a photodetector.

FIG. 13 (prior art) is a schematic illustration of an x-ray detector apparatus 1300 that has a cavity detector configuration. In particular, the apparatus 1300 includes a scintillating phosphor screen 1302 with grazing incidence illumination. The scanning x-ray beam 114 enters through a beam entrance window 1362, is incident at the screen 1302, and then scintillation light produced thereby is detected inside the empty cavity detector apparatus 1300 using multiple, side-mounted PMTs 208. The entire apparatus is encompassed by a housing 1360. The apparatus 1300 is deficient for many reasons, including being bulky, even for a single channel, being expensive, in that it requires many PMTs 208 in order to obtain appreciable scintillation light collection. The apparatus 1300 is also a single-energy apparatus that does not enable multiple energy channels, but is only a single-energy x-ray energy detector. Furthermore, the apparatus 1300 is configured only as a single-spatial-channel detector apparatus, limiting its usefulness for obtaining high-resolution transmission x-ray images.

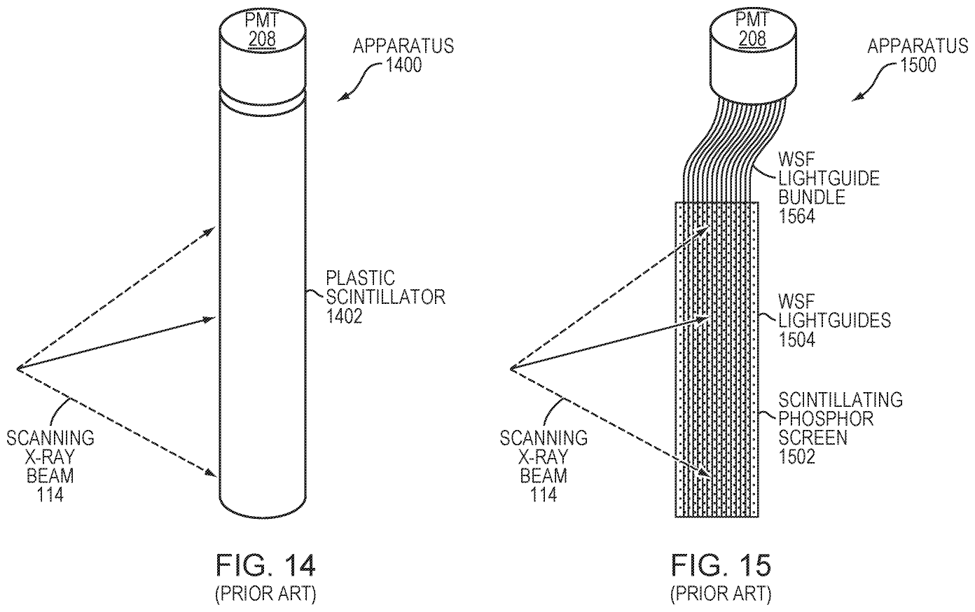

FIG. 14 (prior art) illustrates another existing x-ray detector apparatus 1400, in which a solid plastic scintillator 1402 not only produces the scintillation light but also is used as a light guide to guide scintillation light to the PMT 208, which is end-mounted. Similar, to the apparatus of FIG. 13, the apparatus 1400 is bulky, even for a single detector channel, and it is also expensive and heavy. The apparatus 1400 further is only useful for a single x-ray energy channel and a single spatial channel.

Another significant disadvantage of the apparatus 1400 is that it relies on Compton scattering interaction of the scanning x-ray beam with the plastic scintillator 1402. This results in low efficiency at absorbing x-rays in the plastic scintillator 1402, as well as low light output, especially for lower energy x-rays in the scanning x-ray beam 114. There are still further drawbacks and disadvantages of the apparatus 1400. The plastic scintillator material 1402 tends to absorb its own scintillation light, resulting in reduced light output to the PMT and, hence, limits the signal-to-noise ratios that are attainable in the image. Still further, the plastic scintillator 1402 is susceptible to detecting cosmic ray background, which introduces speckle into a transmission image created from a signal output by the PMT 208.

FIG. 15 (prior art) illustrates another existing apparatus 1500 for detecting x-rays, which is Wavelength-Shifting Fiber (WSF) based. The scanning x-ray beam 114 is incident at a scintillating phosphor screen 1502. Scintillation light that is produced by the scintillating phosphor screen 1502 is coupled into WSF light guides 1504. As noted hereinabove, because the WSF light guides 1504 must be limited in diameter (typically 1 mm to 2 mm) in order to preserve and guide scintillation light to the PMT 208, an entire array of WSF light guides 1504 attached to the scintillating phosphor screen 1502 must be used. All of these WSF light guides must be bundled and routed appropriately to a PMT, as illustrated by the bundle 1564.

Like the apparatuses 1300 and 1400 of FIGS. 13 and 14, respectively, the apparatus 1500 is relatively bulky, even for a single detector channel. As noted above, the WSF fibers are expensive, and many are required, not only increasing expense but also complicating the manufacturing process. Furthermore, WSF fibers are inefficient and capture only a small fraction of scintillation light produced, such as on the order of 1% of the scintillation light produced. This limits the signal-to-noise ratio that may be obtained in the apparatus 1500 and similar detectors. Furthermore, complicating the manufacturing difficulty and expense, two layers of scintillators and WSF light guides, and two fiber bundles, are required for dual-energy operation. Still further, the apparatus 1500 provides only a single spatial channel and does not provide easy replication of energy channels or spatial channels for the benefits described herein above for embodiment x-ray detectors.

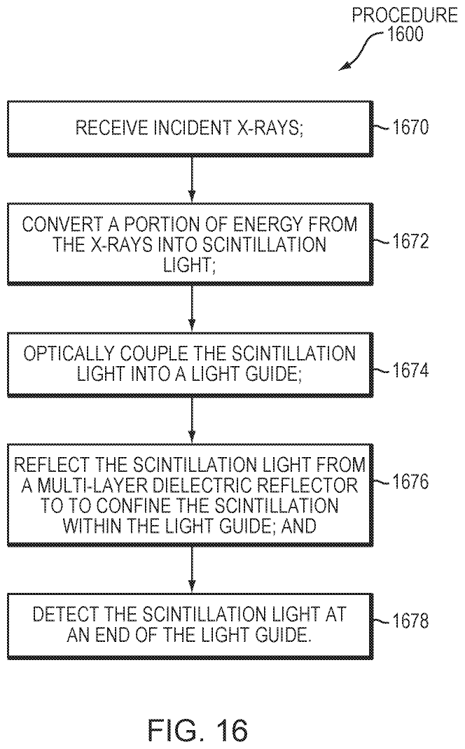

FIG. 16 is a flow diagram illustrating a procedure 1600 for detecting x-rays. At 1670, incident x-rays are received. At 1672, a portion of energy from the x-rays is converted into scintillation light. At 1674, the scintillation light is optically coupled into a light guide. At 1676, the scintillation light is reflected from a multi-layer dielectric reflector in order to confine the scintillation light within the light guide. At 1678, the scintillation light is detected at an end of the light guide.

As will be understood in view of this description and the drawings, embodiment procedure 1600 may be modified to detect x-rays in any manner described herein in connection with various embodiments. This includes, but is not limited to: employing a system as illustrated in FIGS. 1A-1B, using multi-channel x-ray detectors, such as multi-spatial-channel x-ray detectors and multi-energy-channel x-ray detectors; filtering x-rays; shaping an x-ray pencil beam to create an elliptical beam spot for increased spatial resolution, utilizing PMTs or other photodetectors at both ends of a light guide, etc.

While example embodiments have been particularly shown and described, it will be understood by those skilled in the art that various changes in form and details may be made therein without departing from the scope of the embodiments encompassed by the appended claims.

What is claimed is:

1. An x-ray detector comprising:
a scintillator structure defining a scintillator volume configured to receive incident x-rays and to convert a portion of energy from the x-rays into scintillation light;
a light guide that is mechanically coupled to the scintillator structure and optically coupled to the scintillator volume;
a multi-layer dielectric reflective material at least partially surrounding the light guide and the scintillator volume, the reflective material configured to confine the scintillation light within the light guide via reflection; and
a photodetector optically coupled to an end of the light guide, the light guide being configured to guide the scintillation light from the scintillator volume to the photodetector for detection of the scintillation light.

2. The x-ray detector of claim 1, wherein the photodetector is a first photodetector and the end of the light guide is a first end, the x-ray detector further comprising a second photodetector optically coupled to a second end of the light guide and configured to receive a portion of the scintillation light that is guided by the light guide.

3. The x-ray detector of claim 1, wherein the x-rays are part of a scanning x-ray pencil beam that can scan a target over a scan angle, the scintillator volume having a length enabling the scintillator volume to receive, over an entirety of the scan angle, x-rays from the x-ray pencil beam that are transmitted through the target.

4. The x-ray detector of claim 1, wherein the x-ray detector is a multi-channel x-ray detector and further comprises:
a plurality of scintillator structures defining respective scintillator volumes configured to receive the incident x-rays and to convert respective portions of energy from the x-rays into scintillation light;
a plurality of light guides that are mechanically coupled to respective scintillator structures and optically coupled to respective ones of the plurality of scintillator volumes; and
a plurality of photodetectors optically coupled to respective ends of respective ones of the plurality of light guides, the plurality of light guides being configured to guide the scintillation light from respective scintillator volumes to respective photodetectors for detection of the scintillation light from respective scintillator volumes.

5. The x-ray detector of claim 4, further configured to be a multi-energy-channel x-ray detector, wherein the x-rays include relatively lower-energy x-rays and relatively higher-energy x-rays, and wherein at least one first of the scintillator volumes is a low-energy scintillator volume optimized to receive the relatively lower-energy x-rays, and wherein at least one second of the scintillator volumes is a high-energy scintillator volume that is optimized to receive the relatively higher-energy x-rays.

6. The x-ray detector of claim 5, further including an x-ray filter that is mechanically coupled to the structure defining the high-energy scintillator volume or arranged between the structure defining the high-energy scintillator volume and the structure defining the low-energy scintillator volume, the x-ray filter being configured to block the relatively lower-energy x-rays from being received at the high-energy scintillator volume.

7. The x-ray detector of claim 5, wherein the low-energy and high-energy scintillator volumes have first and second thicknesses, respectively, in a direction of incidence of the incident x-rays, and wherein the second thickness is greater than the first thickness.

8. The x-ray detector of claim 5, wherein the low-energy and high-energy scintillator volumes are formed of mutually different scintillator materials that are optimized for detecting the lower-energy x-rays and the higher-energy x-rays, respectively.

9. The x-ray detector of claim 4, further configured to be a multi-spatial-channel x-ray detector, at least two of the plurality of scintillator volumes are arranged spatially to receive different spatial portions of the incident x-rays.

10. The x-ray detector of claim 9, wherein the incident x-rays form an elliptical x-ray beam spot, and wherein the at least two scintillator volumes are arranged spatially with respect to each other such that both of the at least two scintillator volumes can receive portions of the elliptical x-ray beam spot.

11. The x-ray detector of claim 1, wherein the photodetector is a photomultiplier tube (PMT).

12. The x-ray detector of claim 1, wherein a width of the scintillator volume is smaller than a width of the light guide, both of the widths being measured in a common direction perpendicular to an angle of incidence of the incident x-rays.

13. The x-ray detector of claim 1, wherein the scintillator volume has length and width dimensions that are perpendicular to each other and to an angle of incidence of the incident x-rays, a length-to-width ratio being between about 10:1 and about 250:1.

14. The x-ray detector of claim 13, wherein the length-to-width ratio is between about 20:1 and about 100:1.

15. The x-ray detector of claim 14, wherein the length-to-width ratio is between about 30:1 and about 60:1.

16. The x-ray detector of claim 1, wherein a length of the scintillator volume measured perpendicular to an angle of incidence of the incident x-rays is between about 20 inches and about 200 inches.

17. The x-ray detector of claim 16, wherein the length of the scintillator volume is between about 40 inches and about 160 inches.

18. The x-ray detector of claim 1, wherein a width of the scintillator volume measured perpendicular to an angle of incidence of the incident x-rays is between about 0.1 inches and about 1 inch.

19. The x-ray detector of claim 1, wherein the width of the scintillator volume is between about 0.5 inches and about 3 inches.

20. The x-ray detector of claim 1, wherein the light guide is an acrylic light guide.

21. The x-ray detector of claim 1, wherein the light guide has a circular cross-sectional profile.

22. The x-ray detector of claim 1, wherein the light guide has a rectangular cross-sectional profile.

23. The x-ray detector of claim 1, wherein the multi-layer dielectric reflective material has a reflectivity of at least 95% for the scintillation light.

24. The x-ray detector of claim 23, wherein the multi-layer dielectric reflective material has a reflectivity of at least 98% for the scintillation light.

25. An x-ray imaging system comprising:
a scanner configured to output a scanning pencil beam of x-rays toward a target;
a backscatter detector configured to detect x-rays that are scattered from the target as a result of the pencil beam being incident at the target; and
the x-ray detector of claim 1, wherein the incident x-rays are part of the pencil beam and are transmitted through the target.

26. The x-ray imaging system of claim 25, further comprising a processor that is configured to receive signals from the x-ray detector of claim 1 and to form an x-ray transmission image of the target therefrom.

27. A method of detecting x-rays, the method comprising:
receiving incident x-rays;
converting a portion of energy from the x-rays into scintillation light;
optically coupling the scintillation light into a light guide;
reflecting the scintillation light from a multi-layer dielectric reflector to confine the scintillation within the light guide; and
detecting the scintillation light at an end of the light guide.

28. An x-ray detector comprising:
means for receiving incident x-rays;
means for converting a portion of energy from the x-rays into scintillation light;
means for optically coupling the scintillation light into a light guide;
means for reflecting the scintillation light from a multi-layer dielectric reflector to confine the scintillation within the light guide; and
means for detecting the scintillation light at an end of the light guide.
